(19) United States
(12) Patent Application Publication
(10) Pub. No.: US 2010/0083846 A1
(43) Pub. Date: Apr. 8, 2010

(54) Cooking Grill

(76) Inventor: Marsha Y. Adams, Detroit, MI (US)

Correspondence Address: HARSHAW RESEARCH, INC., 210 W. TECUMSEH STREET, OTTAWA, KS, 66067, US

(21) Appl. No.: 12/247,663

(22) Filed: Oct. 8, 2008

(51) Int. Cl. A47J 37/00

(52) U.S. Cl. 99/339

(57) ABSTRACT

A cooking grill includes a housing having a generally open internal area and an open upper end. The grill includes an electrical heating element having a heating portion and a first coupling component. The grill includes a gas heating element having a heating portion and a second coupling component. A third coupling component complementary to the first coupling component allows the first and third coupling components to be selectively joined. An electrical control regulates an amount of electricity delivered to the third coupling component. A fourth coupling component allows the second and fourth coupling components to be selectively joined. A gas control regulates an amount of gas passed to the fourth coupling component. A food support element is selectively positionable over the support element generally adjacent the housing upper end.

### BACKGROUND OF THE INVENTION

This invention relates generally to cooking devices and, more particularly, to a hybrid cooking grill selectively utilizing electric or natural gas heat sources for either indoor or outdoor use.

Although many people love to grill their food, it is frequently infeasible to do so either because a resident has no access to an outside area needed to grill with an open flame or where a grill is too large or bulky to move to a feasible location. Further, many people would like to simulate the grilling experience indoors but can not do so for safety reasons or, again, because the grill is too large to move inside.

Various devices have been proposed in the art for portable heating devices and for cooking grills. Although assumably effective for their intended purposes, the existing devices and proposals do not provide a compact and portable grill that may be used effectively both indoors and outdoors by selectively utilizing either electric or gas heat sources.

Therefore, it would be desirable to have a cooking grill that is compact, easily transportable, and easy to set up for use as either an electric or gas grill. Further, it would be desirable to have a cooking grill that is safe to use in either heating mode by preventing both modes from being operable at the same time. In addition, it would be desirable to have a cooking grill that produces actual flames when utilizing gas and includes a heating element when utilizing electricity.

### SUMMARY OF THE INVENTION

A cooking grill according to the present invention includes a housing having a generally open internal area and an open upper end. The cooking grill includes an electrical heating element having a heating portion and a first coupling component. The grill includes a gas heating element having a heating portion and a second coupling component. A third coupling component is complementary to the first coupling component for allowing the first and third coupling components to be selectively joined. An electrical control is at least partially outside the housing and in electrical communication with a power cord and the third coupling component to control an amount of electricity passed from the power cord to the third coupling component. A fourth coupling component is complementary to the second coupling component for allowing the second and fourth coupling components to be selectively joined. A gas control is at least partially outside the housing and in communication with a gas supply line and the fourth coupling component to control an amount of gas passed from the gas supply line to the fourth coupling component. The grill includes a support element in the housing, the support element having at least one first receiving component to support the electrical heating element in the housing internal area and at least one second receiving component to separately support the gas heating element in the housing internal area. A food support element is selectively positionable over the support element generally adjacent the housing upper end.

Therefore, a general object of this invention is to provide a cooking grill that selectively utilizes either an electric or gas power source.

Another object of this invention is to provide a cooking grill, as aforesaid, that permits only one power source to be used at a time.

Still another object of this invention is to provide a cooking grill, as aforesaid, that may be used indoors or outdoors and which is easily transportable between locations.

Yet another object of this invention is to provide a cooking grill, as aforesaid, that collects grease and is easy to clean.

A further object of this invention is to provide a cooking grill, as aforesaid, that is user friendly to use and cost-effective to manufacture.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1a is a perspective view of a cooking grill in a closed configuration according to a preferred embodiment of the present invention;

FIG. 1b is another perspective view of the cooking grill as in FIG. 1a in an open configuration and in use with a cooking grid food support element;

FIG. 1c is another perspective view of the cooking grill as in FIG. 1a in an open configuration and in use with a solid surface food support element;

FIG. 2 is an exploded view of the cooking grill as in FIG. 1b;

FIG. 3a is a side view of the cooking grill as in FIG. 1b;

FIGS. 3b to 3d are an isolated view on an enlarged scale of a portion of the cooking grill as in FIG. 3a illustrating electric and gas controls in use;

FIG. 4a is another perspective view of the cooking grill as in FIG. 1b;

FIG. 4b is an isolated view taken on an enlarged scale from a portion of FIG. 4a illustrating a grease tray in a closed configuration;

FIG. 4c is an isolated view taken on an enlarged scale from a portion of FIG. 4a illustrating a grease tray in an open configuration;

FIG. 5a is another side view of the cooking grill as in FIG. 1b in an upright and level configuration;

FIG. 5b is another side view of the cooking grill as in FIG. 5a in a tilted configuration;

FIG. 6a is a top view of the cooking grill as in FIG. 1b with the food support member removed;

FIG. 6b is an isolated view on an enlarged scale taken from a portion of FIG. 6a; and

FIG. 7 is a rear perspective view of the cooking grill as in FIG. 1a.

### DESCRIPTION OF THE PREFERRED EMBODIMENT

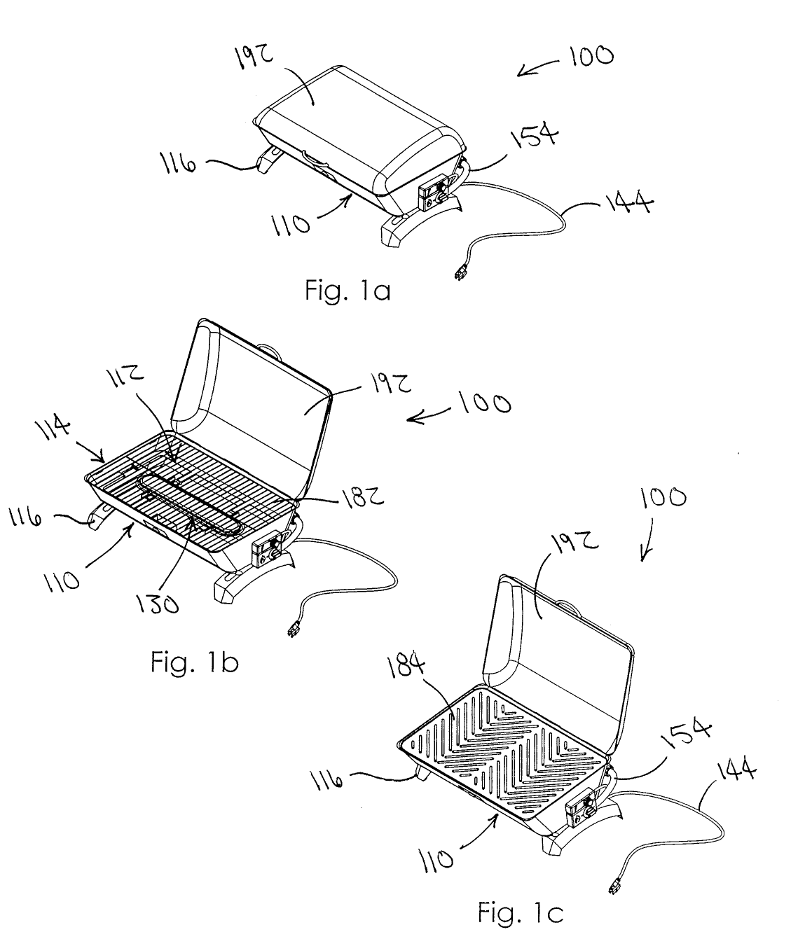

A cooking device will now be described in detail with reference to FIG. 1a through FIG. 7 of the accompanying drawings. More particularly, a cooking grill 100 includes a housing 110, an electrical heating element 120, and a gas heating element 130.

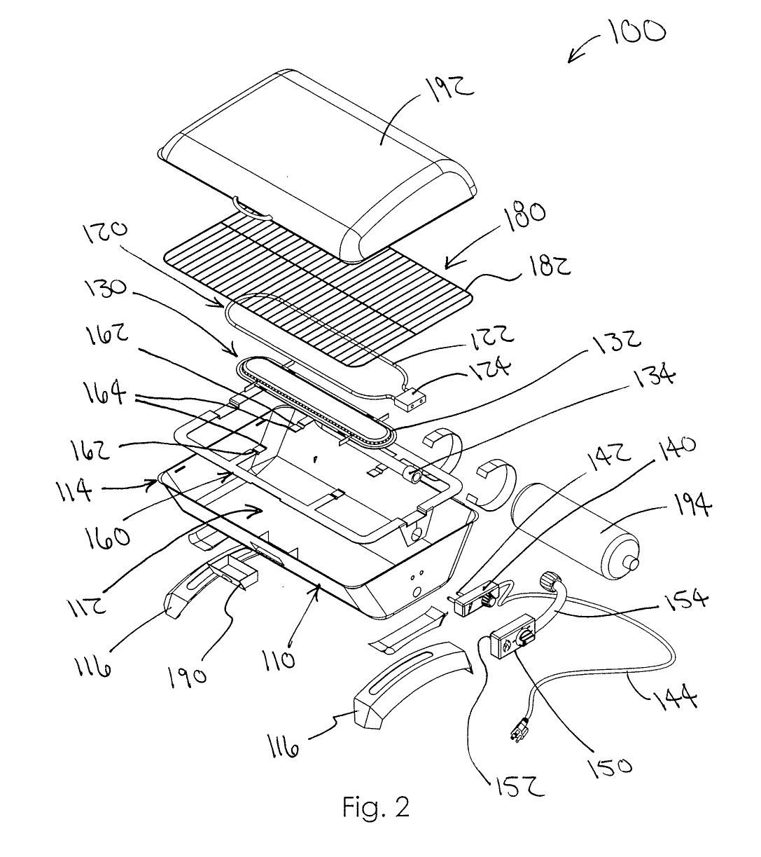

As shown in FIG. 2, the housing 110 has a generally open internal area 112 and an open upper end 114. The housing 110 may be constructed of metal, ceramic, and/or any other appropriate material and may be any desired size. At least one leg 116 may raise the housing 110 above a floor surface (e.g., a patio, table top, counter top, etc.).

Still referring to FIG. 2, the electrical heating element 120 has a heating portion 122 and a first coupling component 124. The heating portion 122 is an electrical resistor capable of turning electrical energy into heat, and the coupling component 124 is a fitting (e.g., electrical plug). The gas heating element 130 has a heating portion 132 and a second coupling component 134. The heating portion 132 is a gas burner, and the coupling component 134 is a fitting (e.g., a coupler fitting).

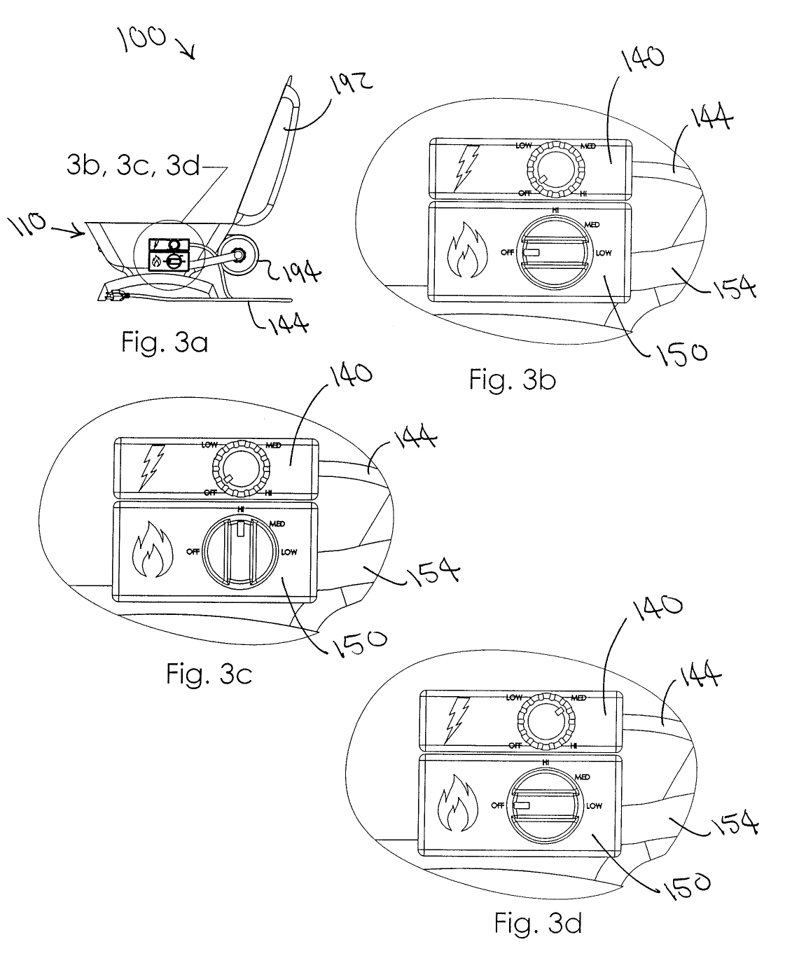

An electrical control 140 (i.e., a control to regulate electricity) is at least partially outside the housing 110 (FIGS. 3a-3d) and is in electrical communication with a third coupling component 142 (FIG. 2) and a power cord 144 (i.e., a cord for accessing a power grid or battery) to control an amount of electricity passed from the power cord 144 to the third coupling component 142. The third coupling component 142 (e.g., electrical plug) is complementary to the first coupling component 124 for allowing the first and third coupling components 124, 142 to be selectively joined. Similarly, a gas control 150 (i.e., a control to regulate gas) is at least partially outside the housing 110 (FIGS. 3a-3d) and is in communication with a fourth coupling component 152 (FIG. 2) and a gas supply line 154 to control an amount of gas passed from the gas supply line 154 to the fourth coupling component 152. The fourth coupling element 152 (e.g., coupler fitting) is complementary to the second coupling component 134 for allowing the second and fourth coupling components 134, 152 to be selectively joined.

A support element 160 is positioned in the housing 110, as shown in FIG. 2, and is configured to support the electrical heating element 120 and the gas heating element 130 in the housing internal area 112. More particularly, the support element 160 may have one or more receiving components 162 (e.g., a notch, lip, and/or other receiving structure) to support the electrical heating element 120 in the internal area 112 and one or more receiving components 164 (e.g., a notch, lip, and/or other receiving structure) to separately support the gas heating element 130 in the internal area 112.

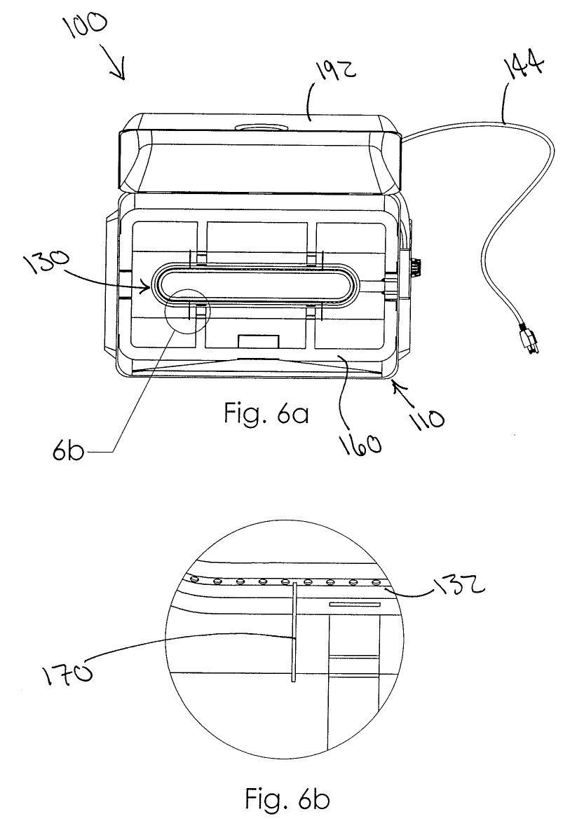

Various means for allowing only one of the electrical heating element 120 and the gas heating element 130 to be supported by the support element 160 at one time may be included. For example, the electrical heating element 120 and/or the gas heating element 130 may include a flange 170 that prevents both heating elements 120, 130 to be simultaneously supported by the support element 160. FIG. 6b shows an exemplary embodiment where the gas heating element 130 includes the flange 170.

Additionally, various means for ensuring that electricity does not pass through the third coupling component 142 simultaneously with gas passing through the fourth coupling component 152 may be included. For example, a cap (not shown) may interact with the third coupling component 142 when the first and third coupling components 124, 142 are not joined together and a cap (not shown) may interact with the fourth coupling component 152 when the second and fourth coupling components 134, 152 are not joined together. In some embodiments, the electrical control 140 and the gas control 150 may be electrically (e.g., through circuitry or a processor) or mechanically joined together so that at least one of the electrical control 140 and the gas control 150 is “off” at all times, as shown in FIGS. 3b-3d, to restrict the respective flow of electricity and gas.

At least one food support element 180 (e.g., a cooking grid 182 or solid heating surface 184) is selectively positionable over the support element 160 generally adjacent the housing upper end 114. As shown in FIG. 1b, the cooking grid 182 may be coupled to the housing 110 and/or the support element 160 to be located generally adjacent the housing upper end 114, and it may be desirable to utilize the cooking grid 182 when the gas heating element 130 is in the housing internal area 112. As shown in FIG. 1c, the solid heating surface 184 may be coupled to the housing 110 and/or the support element 160 to be located generally adjacent the housing upper end 114, and it may be desirable to utilize the solid heating surface 184 when the electrical heating element 120 is in the housing internal area 112.

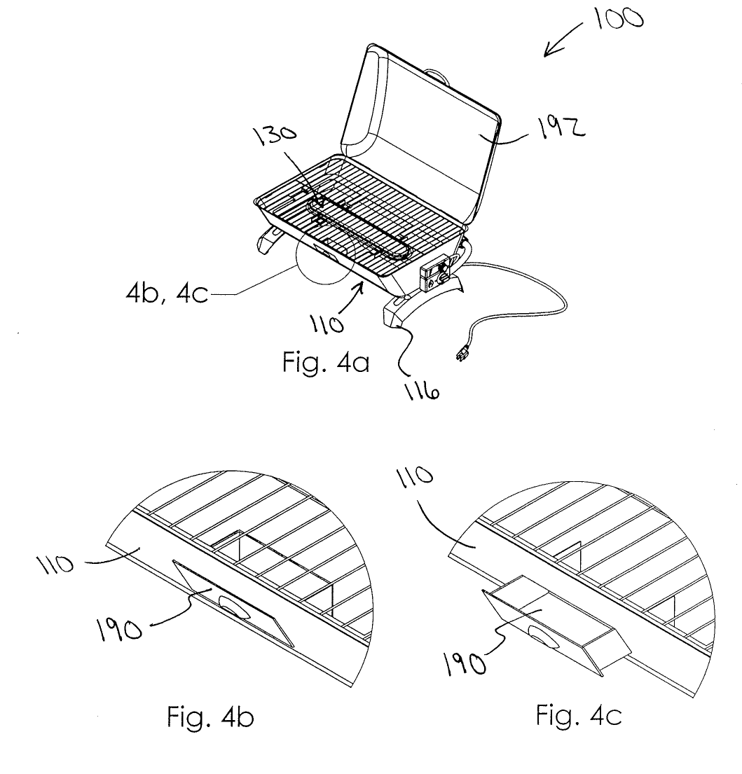

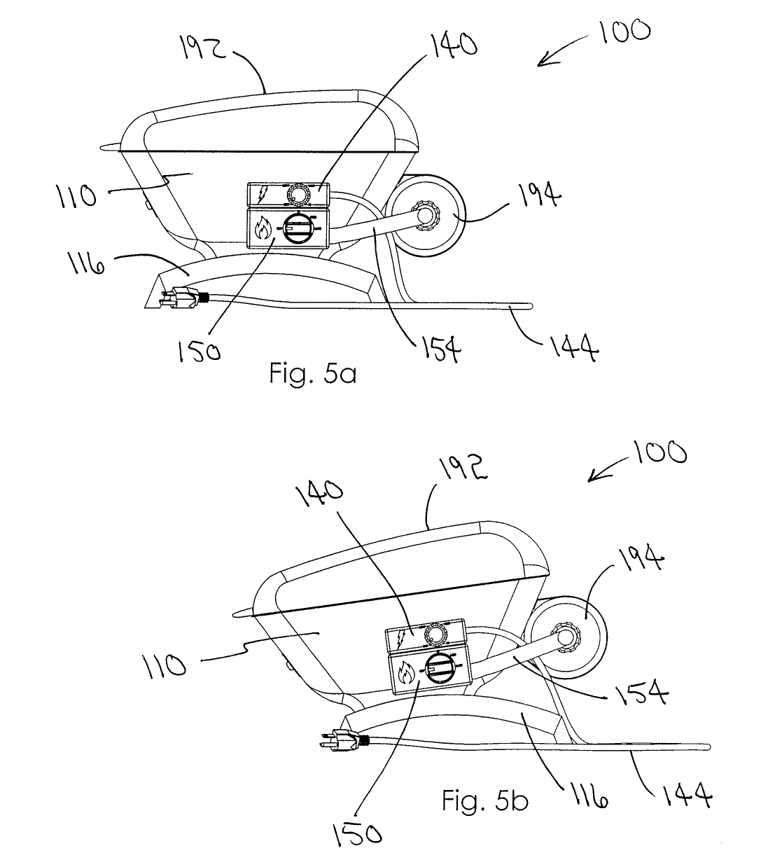

FIGS. 4a-4c show that a tray 190 may be removably positioned in the housing internal area 112 to catch grease (e.g., from atop the solid heating surface 184). To direct grease from the solid heating surface 184, the solid heating surface 184 may be tilted toward the tray 190. More particularly, the configuration of the solid heating surface 184 may be angled, the coupling of the solid heating surface 184 generally adjacent the housing upper end 114 may cause an incline, or the housing 110 may be angled (e.g., by angling the housing 110 relative to legs 116 as shown in FIG. 5b).

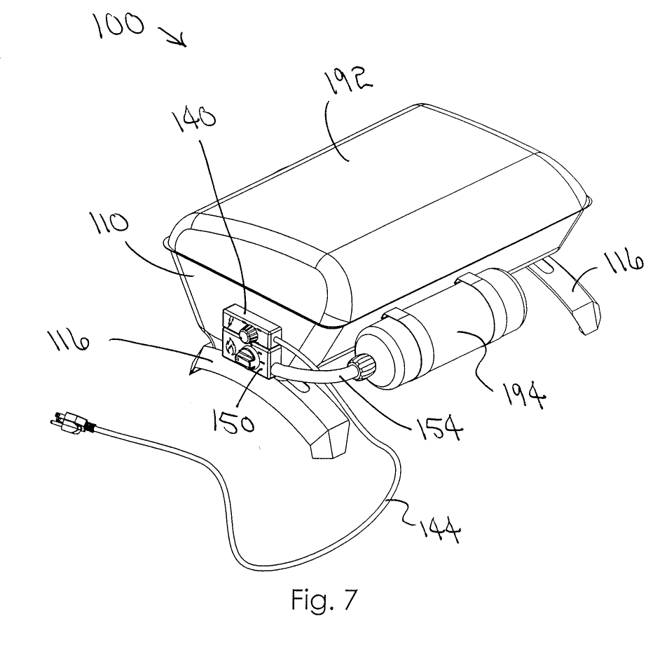

As shown in FIG. 7, a lid 192 and a gas container 194 may be coupled to the housing 110. The lid 192 is movable between a first position covering the open upper end 114 of the housing 110 (FIG. 1a) and a second position exposing the open upper end 114 of the housing 110 (FIGS. 1b and 1c). The gas container 194 is outside the internal area 112 and is in communication with the gas supply line 154.

In use, a person may choose to cook using different heat sources. The choice may be based on location (e.g., inside vs. outdoors), availability of electricity or gas, or other considerations. If electricity is to be used, the electrical heating element 120 may be placed in the housing internal area 112 and supported by the support element 160 (e.g., by the receiving components 162), and the first coupling component 124 may be coupled to the third coupling component 142 (FIG. 2). The solid heating surface 184 may be coupled to the housing 110 and/or the support element 160 generally adjacent the housing upper end 114 (FIG. 1c), and the housing 110 may be tilted relative to the legs 116 (FIG. 5b) to angle the solid heating surface 184 toward the tray 190. The power cord 144 may be plugged into an electrical outlet, and the electrical control 140 may be used (FIG. 3d) to allow electricity to pass from the power cord 144 through the first and third coupling components 124, 142 to the heating portion 122 of the heating element 120. The heating portion 122 may turn the electricity into heat (e.g., through resistance), and the heat may warm the solid heating surface 184. Food may be cooked on the warmed solid heating surface 184, and any grease from the food may enter the tray 190 to be collected and discarded.

If gas is to be used, the gas heating element 130 may be placed in the housing internal area 112 and supported by the support element 160 (e.g., by the receiving components 164), and the second coupling component 134 may be coupled to the fourth coupling component 152 (FIG. 2). The cooking grid 182 may be coupled to the housing 110 and/or the support element 160 generally adjacent the housing upper end 114 (FIG. 1b). The gas control 150 may be used (FIG. 3c) to allow gas to pass from the gas container 194 through the gas supply line 154 and the second and fourth coupling components 134, 152 to the heating portion 132 of the gas heating element 130. The heating portion 132 may turn the gas into heat (e.g., through combustion), and the heat may warm food placed on the cooking grid 182.

As set forth above, various safety features may be included to allow only one of the electrical heating element 120 and the gas heating element 130 to be supported by the support element 160 at one time and to ensure that electricity does not pass through the third coupling component 142 simultaneously with gas passing through the fourth coupling component 152.

It is understood that while certain forms of this invention have been illustrated and described, it is not limited thereto except insofar as such limitations are included in the following claims and allowable functional equivalents thereof.

1. A cooking device, comprising:
a housing having a generally open internal area and an open upper end;
an electrical heating element having a heating portion and a first coupling component;
a gas heating element having a heating portion and a second coupling component;
a third coupling component complementary to said first coupling component for allowing said first and third coupling components to be selectively joined;
an electrical control at least partially outside said housing and being in electrical communication with a power cord and said third coupling component to control an amount of electricity passed from said power cord to said third coupling component;
a fourth coupling component complementary to said second coupling component for allowing said second and fourth coupling components to be selectively joined;
a gas control at least partially outside said housing and being in communication with a gas supply line and said fourth coupling component to control an amount of gas passed from said gas supply line to said fourth coupling component;
a support element in said housing, said support element having at least one first receiving component to support said electrical heating element in said housing internal area and at least one second receiving component to separately support said gas heating element in said housing internal area; and
a food support element selectively positionable over said support element generally adjacent said housing upper end.

2. The cooking device of claim 1, wherein said food support element is one of a cooking grid and a solid heating surface; and further comprising the other of said cooking grid and said solid heating surface; the other of said cooking grid and said solid heating surface being selectively positionable over said support element generally adjacent said housing upper end.

3. The cooking device of claim 2, wherein at least one of said electrical heating element and said gas heating element includes a flange to allow only one of said electrical heating element and said gas heating element to be supported by said support element at one time.

4. The cooking device of claim 3, further comprising a lid movable between a first position covering said open upper end of said housing and a second position exposing said open upper end of said housing.

5. The cooking device of claim 4, further comprising a gas container coupled to said housing outside said internal area, said gas container being in communication with said gas supply line.

6. The cooking device of claim 5, further comprising means for ensuring that electricity does not pass through said third coupling component simultaneously with gas passing through said fourth coupling component.

7. The cooking device of claim 6, further comprising:
a tray removably positioned in said housing internal area to catch grease from atop said solid heating surface; and
at least one leg coupled to said housing to raise said housing above a floor surface, said housing being movable relative to said at least one leg to tilt said housing.

8. The cooking device of claim 1, wherein at least one of said electrical heating element and said gas heating element includes a flange to allow only one of said electrical heating element and said gas heating element to be supported by said support element at one time.

9. The cooking device of claim 1, further comprising means for ensuring that electricity does not pass through said third coupling component simultaneously with gas passing through said fourth coupling component.

10. A cooking grill, comprising:
a housing having a generally open internal area and an open upper end;
an electrical heating element having a heating portion and a first coupling component;
a gas heating element having a heating portion and a second coupling component;
a third coupling component complementary to said first coupling component for allowing said first and third coupling components to be selectively joined;
an electrical control at least partially outside said housing and being in electrical communication with a power cord and said third coupling component to control an amount of electricity passed from said power cord to said third coupling component;
a fourth coupling component complementary to said second coupling component for allowing said second and fourth coupling components to be selectively joined;
a gas control at least partially outside said housing and being in communication with a gas supply line and said fourth coupling component to control an amount of gas passed from said gas supply line to said fourth coupling component;
a support element in said housing, said support element being configured to separately support said electrical heating element and said gas heating element in said housing internal area;
a cooking grill; and
a solid heating surface; said cooking grid and said solid heating surface being separately coupled to at least one of said housing and said support element for positioning over said support element generally adjacent said housing upper end.

11. The cooking grill of claim 10, further comprising means for allowing only one of said electrical heating element and said gas heating element to be supported by said support element at one time.

12. The cooking grill of claim 11, further comprising means for ensuring that electricity does not pass through said third coupling component simultaneously with gas passing through said fourth coupling component.

13. The cooking grill of claim 12, further comprising:
a lid movable between a first position covering said open upper end of said housing and a second position exposing said open upper end of said housing; and
a gas container coupled to said housing outside said internal area, said gas container being in communication with said gas supply line.

14. The cooking grill of claim 13, further comprising at least one leg coupled to said housing to raise said housing above a floor surface, said housing being movable relative to said at least one leg to tilt said housing.

15. The cooking grill of claim 10, wherein at least one of said electrical heating element and said gas heating element includes a flange to allow only one of said electrical heating element and said gas heating element to be supported by said support element at one time.

16. The cooking grill of claim 10, further comprising means for ensuring that electricity does not pass through said third coupling component simultaneously with gas passing through said fourth coupling component.

17. A cooking grill, comprising:
a housing having a generally open internal area and an open upper end;
an electrical heating element having a heating portion and a first coupling component;
a gas heating element having a heating portion and a second coupling component;
a third coupling component complementary to said first coupling component for allowing said first and third coupling components to be selectively joined;
an electrical control at least partially outside said housing and being in electrical communication with a power cord and said third coupling component to control an amount of electricity passed from said power cord to said third coupling component;
a fourth coupling component complementary to said second coupling component for allowing said second and fourth coupling components to be selectively joined;
a gas control at least partially outside said housing and being in communication with a gas supply line and said fourth coupling component to control an amount of gas passed from said gas supply line to said fourth coupling component;
a support element in said housing, said support element being configured to support said electrical heating element and said gas heating element in said housing internal area; and
a food support element selectively positionable over said support element generally adjacent said housing upper end.

18. The cooking grill of claim 17, further comprising means for allowing only one of said electrical heating element and said gas heating element to be supported by said support element at one time.

19. The cooking grill of claim 17, further comprising means for ensuring that electricity does not pass through said third coupling component simultaneously with gas passing through said fourth coupling component.

20. The cooking grill of claim 17, further comprising:
a lid movable between a first position covering said open upper end of said housing and a second position exposing said open upper end of said housing; and
a gas container coupled to said housing outside said internal area, said gas container being in communication with said gas supply line.
